(19) United States
(12) Patent Application Publication
(10) Pub. No.: US 2013/0258254 A1
(43) Pub. Date: Oct. 3, 2013

(54) LIQUID CRYSTAL DISPLAY

(71) Applicants: Kwang-Hyun KIM, Gunpo-si (KR); Seung Beom PARK, Seoul (KR); Ji-Hoon KIM, Hwaseong-si (KR); Na Young SHIN, Seoul (KR)

(72) Inventors: Kwang-Hyun KIM, Gunpo-si (KR); Seung Beom PARK, Seoul (KR); Ji-Hoon KIM, Hwaseong-si (KR); Na Young SHIN, Seoul (KR)

(73) Assignee: SAMSUNG DISPLAY CO., LTD., Yongin-City (KR)

(21) Appl. No.: 13/587,369

(22) Filed: Aug. 16, 2012

(30) Foreign Application Priority Data
Mar. 30, 2012 (KR) 10-2012-0033253

(51) Int. Cl. G02F 1/1335

(52) U.S. Cl. 349/96

(57) ABSTRACT

Provided is a liquid crystal display. The liquid crystal display according to an exemplary embodiment of the present invention includes a first substrate; a color filter and a light blocking member disposed on the first substrate; a second substrate corresponding to the first substrate; a liquid crystal layer interposed between the first substrate and the second substrate; a first polarizer disposed on an outer surface of the first compensation film; a compensation film disposed on the second substrate and including a biaxial film wherein there is no biaxial film disposed on the first substrate; and a second polarizer disposed on an outer surface of the second compensation film. There may be a first compensation film disposed on the first substrate and including a phase retardation layer having an in-plane phase retardation value (Ro) of 0 and a thickness direction phase retardation value (Rth) of 0.

### CROSS-REFERENCE TO RELATED APPLICATION

This application claims priority to and the benefit of Korean Patent Application No. 10-2012-0033253 filed in the Korean Intellectual Property Office on Mar. 30, 2012, the entire contents of which are incorporated herein by reference.

### BACKGROUND OF THE INVENTION

(a) Field of the Invention

The present invention relates to a liquid crystal display.

(b) Description of the Related Art

A liquid crystal display includes a liquid crystal panel for displaying an image using light. Typically, a backlight assembly is disposed below the liquid crystal panel to supply light to the liquid crystal panel.

The liquid crystal panel includes a first substrate having a thin film transistor and a pixel electrode, a second substrate facing the first substrate and having a common electrode, and a liquid crystal layer interposed between the first substrate and the second substrate.

Liquid crystals within the liquid crystal layer may be operated in a vertical alignment (VA) mode by an electric field generated between a pixel electrode and a common electrode. For example, in the absence of the electric field between the pixel electrode and the common electrode, the liquid crystal panel implements a black image. When electric field is generated between the pixel electrode and the common electrode, the liquid crystal panel implements images having several gray levels.

When the electric field is generated between the pixel electrode and the common electrode, the liquid crystals within the liquid crystal layer are aligned so that angles formed by the liquid crystals and the pixel electrode or the common electrode are smaller than 90 degrees. This alignment causes an image to get brighter. When the liquid crystals are aligned in a vertical direction, in the case where light is incident on the front of a liquid crystal panel, an excellent black image having low luminance is displayed. In the case where light is incident on the side of the liquid crystal panel, the luminance of a black image is exhibited higher compared to the case where the light is incident on the front. This is because the light propagating to the side of the liquid crystal panel passes through the liquid crystal panel obliquely and thus suffers more phase retardation by liquid crystals compared to the light propagating to the front thereof. Light is scattered when passing through a thin film transistor and a color filter, and thus its polarization state is changed. This change in polarization state, in turn, causes light leakage.

As described above, the liquid crystal panel operating in the vertical alignment (VA) mode has a high luminance of the black image, resulting in a low contrast ratio.

The above information disclosed in this Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a vertical alignment (VA) mode liquid crystal display with improved a contrast ratio.

In another aspect, the present invention provides a liquid crystal display, including: a first substrate; a color filter and a light blocking member disposed on the first substrate; a second substrate corresponding to the first substrate; a liquid crystal layer interposed between the first substrate and the second substrate; a first polarizer disposed on the first substrate; a compensation film disposed on the second substrate and including a biaxial film wherein there is no compensation film disposed on the first substrate; and a second polarizer disposed on an outer surface of the compensation film.

Where the compensation film is a second compensation film, there may be a first compensation film that is disposed on the first substrate and includes a phase retardation layer having an in-plane phase retardation value (Ro) of 0 and a thickness direction phase retardation value (Rth) of 0.

A thickness direction phase retardation value of the biaxial film may be about 250 nanometers to about 310 nanometers.

An in-plane phase retardation value of the biaxial film may be about 45 nanometers to about 75 nanometers.

The first compensation film and the second compensation film may include at least one of tri-acetyl-cellulose (TAC), a cyclic olefin polymer (COP)-based resin and an acrylic polymer resin.

The acrylic polymer resin may include polymethylmethacrylate (PMMA), and the thickness direction phase retardation value (Rth) of the first compensation film may be in the range of about −10 nanometers to 0.

The first compensation film may be interposed between the first substrate and the first polarizer.

The liquid crystal display may further include a thin film transistor disposed on the first substrate; a pixel electrode disposed on the thin film transistor; a common electrode disposed on the second substrate; and a spacer disposed between the first substrate and the second substrate, in which liquid crystal molecules of the liquid crystal layer may be aligned by an electric field generated between the pixel electrode and the common electrode.

The spacer and the light blocking member may be formed of the same material.

The second compensation film may be interposed between the second substrate and the second polarizer.

The first polarizer may include a reflective polarization film.

The first polarizer may include a structure in which two films having the same refractive indexes of an X-axis direction and different refractive indexes of a Y-axis direction are stacked in plural.

The first polarizer may include a crystal liquid composite film in which a pitch is repeated along a spiral direction.

The first polarizer may include a diffusing-reflective polarization film.

The first polarizer may include a wire grid polarizer.

In yet another aspect, the present invention provides a liquid crystal display, including: a first substrate; a color filter and a light blocking member disposed on the first substrate; a second substrate corresponding to the first substrate; a liquid crystal layer interposed between the first substrate and the second substrate; a first compensation film disposed on the first substrate; a first polarizer disposed on an outer surface of the first compensation film; a second compensation film disposed on the second substrate; and a second polarizer disposed on an outer surface of the second compensation film, in which the first compensation film has an in-plane phase retardation value (Ro) in the range of about −10 nanometers to 10 nm and a thickness direction phase retardation value (Rth) in the range of about −10 nanometers to about 10 nanometers, and the second compensation film includes a biaxial film.

The thickness direction phase retardation value of the biaxial film may be about 250 nanometers to about 310 nanometers.

An in-plane phase retardation value of the biaxial film may be about 45 nanometers to about 75 nanometers.

The first compensation film and the second compensation film may include at least one of tri-acetyl-cellulose (TAC), a cyclic olefin polymer (COP)-based resin and an acrylic polymer resin.

The liquid crystal display may further include a thin film transistor disposed on the first substrate; a pixel electrode disposed on the thin film transistor; a common electrode disposed on the second substrate; and a spacer disposed between the first substrate and the second substrate, in which liquid crystal molecules of the liquid crystal layer may be aligned by an electric field generated between the pixel electrode and the common electrode.

The spacer and the light blocking member may be formed of the same material.

The first compensation film may be interposed between the first substrate and the first polarizer.

The second compensation film may be interposed between the second substrate and the second polarizer.

According to the exemplary embodiments of the present invention, it is possible to minimize luminance of a black image through an optimized optical design in a structure of the liquid crystal display in which the color filter and the light blocking member are disposed on the lower panel, thereby improving a contrast ratio.

Further, according to the exemplary embodiments of the present invention, it is possible to increase luminance by replacing an absorption type polarizer with a reflective polarization film.

### BRIEF DESCRIPTION OF THE DRAWINGS

FIG. 1 is a cross-sectional view illustrating a liquid crystal display according to an exemplary embodiment of the present invention.

FIG. 2 is a view illustrating the Poincaré sphere illustrating a polarization state according to a light path in the liquid crystal display of FIG. 1.

FIG. 3 is a cross-sectional view illustrating a liquid crystal display according to an exemplary embodiment of the present invention.

FIG. 4 is a cross-sectional view of the Poincaré sphere illustrating a polarization state according to a light path in the liquid crystal display of FIG. 3.

FIG. 5 is a cross-sectional view illustrating a liquid crystal display according to an exemplary embodiment of the present invention.

FIG. 6 is a cross-sectional view illustrating a liquid crystal display according to an exemplary embodiment of the present invention.

FIGS. 7 and 8 are a perspective view and a cross-sectional view illustrating a structure of a reflective polarization film used in the liquid crystal display of FIG. 6.

### DETAILED DESCRIPTION OF THE EMBODIMENTS

Hereinafter, exemplary embodiments of the present invention will be described in detail with reference to the accompanying drawings. As those skilled in the art would realize, the described embodiments may be modified in various different ways without departing from the spirit or scope of the present invention. Exemplary embodiments introduced herein are provided to make the disclosure thorough and complete and sufficiently convey the spirit of the present invention to those skilled in the art.

In the drawings, the thickness of layers, films, panels, regions, etc., are exaggerated for clarity. It will be understood that when a layer is referred to as being “on” another layer or substrate, it can be directly on the other layer or substrate or intervening them may also be present. Like reference numerals designate like elements throughout the specification

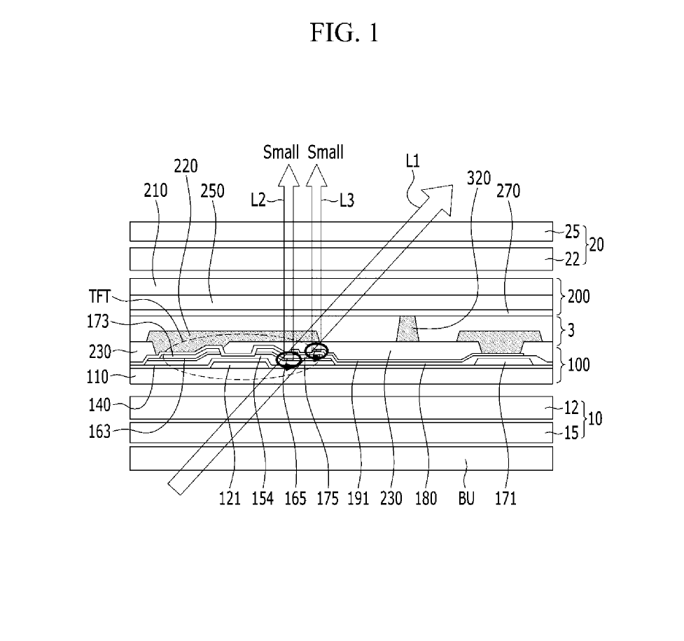

FIG. 1 is a cross-sectional view illustrating a liquid crystal display according to an exemplary embodiment of the present invention. Referring to FIG. 1, the liquid crystal display according to the present exemplary embodiment includes a lower panel 100, an upper panel 200, a first optical unit 10 disposed below the lower panel 100, and a second optical unit 20 disposed on the upper panel 200. The first optical unit 10 includes a first compensation film 12 and a first polarizer 15, and the second optical unit 20 includes a second compensation film 22 and a second polarizer 25. Here, the first polarizer 15 and the second polarizer 25 may be absorption type polarizers.

The lower panel 100 includes a first substrate 110, a gate line 121 including a gate electrode disposed on the first substrate 110, a gate insulating layer 140 disposed on the gate line 121, a semiconductor layer 154 disposed on the gate insulating layer 140, ohmic contacts 163 and 165 disposed on the semiconductor layer 154, a data line 171 disposed on the ohmic contacts 163 and 165 and including a source electrode 173 and a drain electrode 175, a passivation layer 180 formed to cover the source electrode 173 and the drain electrode 175, a pixel electrode 191 disposed on the passivation layer 180, and a color filter 230 disposed on the pixel electrode 191. The color filter 230 may be disposed below the pixel electrode 191 unlike that shown in FIG. 1.

A light blocking member 220 is disposed on the color filter 230. The light blocking member 220 is referred to as a black matrix, and prevents light leakage between the pixel electrodes 191. The light blocking member 220 may be disposed at a portion corresponding to the gate line 121 and the data lines 171a and 171b and a portion corresponding to a thin film transistor. The light blocking member 220 may be disposed between the adjacent color filters 230.

As described above, in the liquid crystal display according to the exemplary embodiment of the present invention, the color filter 230 and the light blocking member are disposed on the lower panel 100.

The upper panel 200 includes an overcoat 250 disposed on the second substrate 210, and a common electrode 270 disposed on the overcoat 250. The common electrode 270 is made of a transparent conductive material and receives common voltage. The overcoat 250 may be omitted.

In the present exemplary embodiment, since the upper panel 200 does not have a pattern-shaped structure (Ex. thin film transistor or color filter), a scattering element is absent. Hence, scattering and light leakage in the front are minimized.

The liquid crystal display according to the present exemplary embodiment further includes a liquid crystal layer 3 interposed between the lower panel 100 and the upper panel 200. Further, a spacer 320 for maintaining a cell gap of the liquid crystal layer 3 is disposed between the lower panel 100 and the upper panel 200. The spacer 320 may be made of the same material as the light blocking member 220, and formed during the same process simultaneously. However, the spacer 320 and the light blocking member 220 are not limited to being formed simultaneously and during the same process step, and may be made of different materials or formed during different processes.

The gate electrode 121, the source electrode 173, and the drain electrode 175 constitute a thin film transistor (TFT), and the thin film transistor (TFT) is electrically connected to the pixel electrode 191. The pixel electrode 191 is made of a transparent conductive material, and receives data voltages transferred from the data line 171 through the thin film transistor (TFT).

The liquid crystal layer 3 may be driven in a vertical alignment mode. When there is no electric field between the pixel electrode 191 and the common electrode 270, liquid crystal molecules of the liquid crystal layer 3 are aligned in a vertical direction to the surface of the first substrate 110. When an electric field is generated between the pixel electrode 191 and the common electrode 270, liquid crystals of the liquid crystal layer 3 are inclined with respect to the surface of the first substrate 110, and the angle of inclination increases with the intensity of the electric field, such that the liquid crystal molecules are aligned in a horizontal direction to the surface of the first substrate 110.

The first optical unit 10 includes the first polarizer 15 disposed below the lower panel 100, and the first compensation film 12 disposed between the first polarizer 15 and the lower panel 100. The first compensation film 12 according to the exemplary embodiment of the present invention may be formed of a negative C-plate, and the second compensation film 22 may be formed of a biaxial film. Light generated from a light source BU disposed below the first polarizer 15 transmits the first polarizer 15 and the first compensation film 12 and is incident on the lower panel 100. The second optical unit 20 includes a second polarizer 25 disposed on the upper panel 200, and the second compensation film 22 disposed between the second polarizer 25 and the upper panel 200. The second compensation film 22 according to the exemplary embodiment of the present invention may be formed of a biaxial film.

In general, the compensation film has refractive indexes nₓ, n_{y}, and nz for x, y, and z-axis directions. The negative C-plate satisfies a refractive index relationship of nx=ny>nz, and the biaxial film satisfies a refractive index relationship of nx*ny*nz. An in-plane phase retardation value (Ro) and a thickness direction phase retardation value (Rth) are values defined by the following Equations 1 and 2, respectively, where d denotes a thickness of the compensation film.

Ro=(nₓ−n_{y})*d Equation 1:

Rth=((nₓ+n_{y})/2−n_{z})*d Equation 2:

The first compensation film 12 and the second compensation film 22 may be formed of at least one of tri-acetyl-cellulose (TAC), a cyclic olefin polymer (COP)-based resin and an acrylic polymer resin. The acrylic polymer resin may include polymethylmethacrylate (PMMA).

The light travels through the lower panel 100, the liquid crystal layer 3, and the upper panel 200 in sequence, and passes through the second optical unit 20 to display an image.

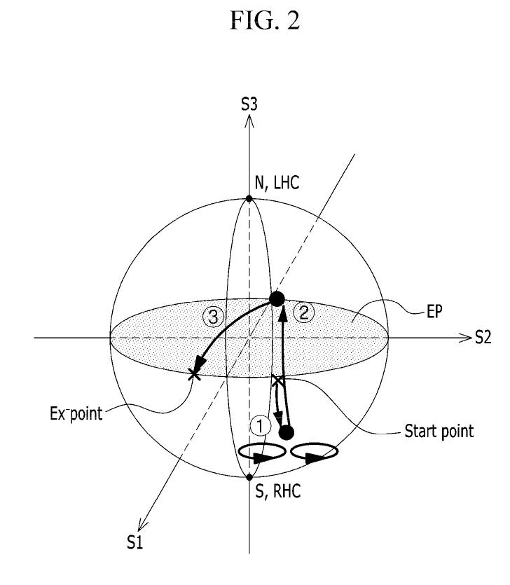

FIG. 2 is a view illustrating the Poincaré sphere illustrating a polarization state according to a light path in the liquid crystal display of FIG. 1.

Referring to FIGS. 1 and 2, light L1 is generated from a light source BU disposed below the first optical unit 10. When the light L1 passes through the first optical unit 10, its polarization state on the Poincaré sphere moves along an arrow \textcircled{1} (see FIG. 2) and is positioned between the south pole S and an equatorial plane EP. The light passing through the first optical unit 10 is incident on the lower panel 100 and strikes the thin film transistor (TFT) and the color filter 230 to be scattered as rays L2 and L3. In addition, the light may scatter at the light blocking member 220 similarly to a scattering form in the thin film transistor (TFT) and the color filter 230. Here, scattered ray L2 by the thin film transistor (TFT) and scattered ray L3 by the color filter 230 cause less light leakage compared to scattering that occurs in a circular polarization state. When light passing through the lower panel 100 passes through the liquid crystal layer 3, a polarization state on the Poincaré sphere moves along an arrow \textcircled{2}, and thus is positioned between the equatorial plane EP and the north pole N. When the light passing through the liquid crystal layer 3 is incident on the upper panel 200, and the light passing through the upper panel 200 passes through the second optical unit 20, its polarization state on a Poincaré sphere moves along an arrow \textcircled{3}, and thus reaches an extinction point Ex-point which is positioned on the equatorial plane EP of the Poincaré sphere.

In the present exemplary embodiment, it is possible to increase a contrast ratio by reducing light leakage compared to the case where the first compensation film 12 is formed of a biaxial film, and the second compensation film 22 is formed of a negative C-plate, and the case where both the first compensation film 12 and the second compensation film 22 are formed of biaxial films.

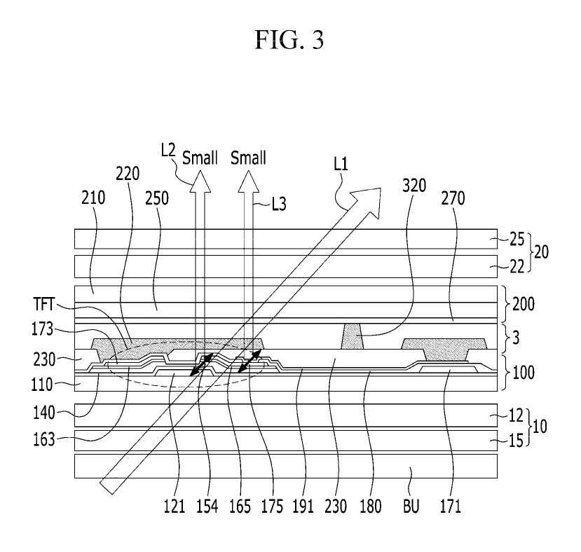

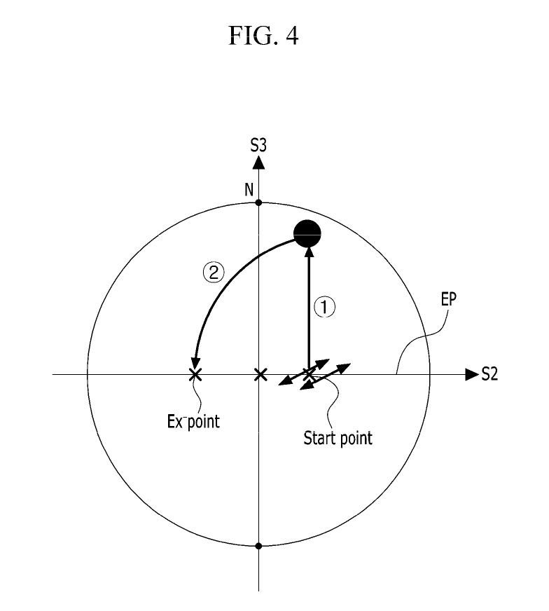

FIG. 3 is a cross-sectional view illustrating a liquid crystal display according to an exemplary embodiment of the present invention. FIG. 4 is a cross-sectional view of the Poincaré sphere illustrating a polarization state according to a light path in the liquid crystal display of FIG. 3.

The exemplary embodiment of FIG. 3 has almost the same constituent elements as the exemplary embodiment of FIG. 1, and thus the description will focus on the differences. Most of the contents described in the exemplary embodiment of FIG. 1 may be applied to the present exemplary embodiment.

In the present exemplary embodiment, a color filter 230 and a light blocking member 220 are disposed on a lower panel 100, a first compensation film 12 is formed of a phase retardation layer having an in-plane phase retardation value (Ro) and a thickness direction phase retardation value (Rth) of about 0, and the second compensation film 22 is formed of a biaxial film having a high thickness direction phase retardation value. In this case, the first compensation film 12 may be formed of a phase retardation layer having an in-plane phase retardation value (Ro) of 0, and a thickness direction phase retardation value (Rth) of 0.

Referring to FIGS. 3 and 4, light L1 generated from a light source BU disposed below a first optical unit 10 passes through the first optical unit 10. In this case, since the phase difference of the first compensation film 12 is almost 0, the polarization state on the Poincaré sphere is almost close to a linear polarization state. Light transmitted through the first optical unit 10 is incident on the lower panel 100 and meets the thin film transistor (TFT) and the color filter 230 to be scattered as rays L2 and L3. Here, since scattered ray L2 generated at the thin film transistor (TFT) and scattered ray L3 generated at the color filter 230 occur in the linear polarization state, light leakage is minimized. In addition, when the light passing through the first optical unit 10 meets the light blocking member 220, the light may be scattered similarly to a scattering form in the thin film transistor (TFT) and the color filter 230. While light passing through the lower panel 100 passes through the liquid crystal layer 3, its polarization state on the Poincaré sphere moves along arrow \textcircled{1}, and thus is positioned very close to the north pole N. When the light passing through the liquid crystal layer 3 is incident on the upper panel 200, and the light that is transmitted through the upper panel 200 passes through the second optical unit 20, its polarization state on the Poincaré sphere moves along arrow \textcircled{2}, and thus reaches an extinction point Ex-point which is positioned on an equatorial plane EP of the Poincaré sphere.

In the present exemplary embodiment, a phase difference of the first compensation film 12 may have an in-plane phase retardation value in the range of −10 nanometers to 10 nanometers and a thickness direction phase retardation value in the range of −10 nanometers to 10 nanometers. A thickness direction phase retardation value of the biaxial film corresponding to the second compensation film 22 may be about 250 nanometers to about 310 nanometers, and an in-plane phase retardation value thereof may be about 45 nanometers to about 75 nanometers. When the first compensation film 12 is made of polymethylmethacrylate (PMMA), the thickness direction phase retardation value (Rth) of the first compensation film 12 may be in the range of about −10 nanometers to 0.

The liquid crystal display according to the exemplary embodiment of the present invention described with reference to FIG. 3 can minimize light leakage due to scattering of light that occurs in the thin film transistor (TFT), the color filter 230 and the light blocking member 220 through an optical design in which the first compensation film 12 disposed between the lower panel 100 and the first polarizer 15 is formed of the phase retardation layer having the in-plane phase retardation value (Ro) of 0 and the thickness direction phase retardation value (Rth) which is close to 0, and the second compensation film 22 disposed between the upper panel 200 and the second polarizer 25 is formed of the biaxial film, in a structure where the color filter 230 and the light blocking member 220 are disposed on the lower panel 100.

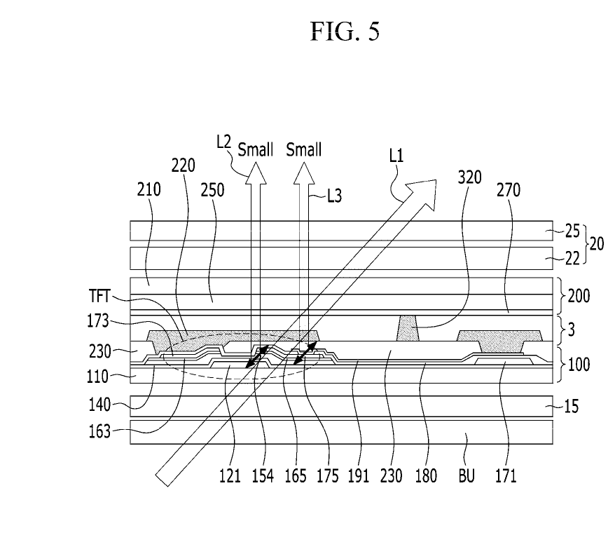

FIG. 5 is a cross-sectional view illustrating a liquid crystal display according to an exemplary embodiment of the present invention.

Referring to FIG. 5, the exemplary embodiment is almost the same as the exemplary embodiment shown in FIGS. 3 and 4, but is different in that the first compensation film is omitted. In other words, there is no compensation film between the lower panel 100 and the first polarizer 15.

A phase retardation layer having a phase difference of about 0, such as the first compensation film described in the exemplary embodiment of FIGS. 3 and 4, hardly contributes to a phase difference. Therefore, like the exemplary embodiment of FIG. 5, when the compensation film is removed between the lower panel 100 and the first polarizer 15, the same optical characteristics are exhibited as those of the phase retardation layer having a phase difference of about 0, as the first compensation film described in the exemplary embodiment of FIGS. 3 and 4. Therefore, the exemplary embodiment of FIG. 5 has an effect of improving a contrast ratio similarly as in the exemplary embodiment of FIGS. 3 and 4.

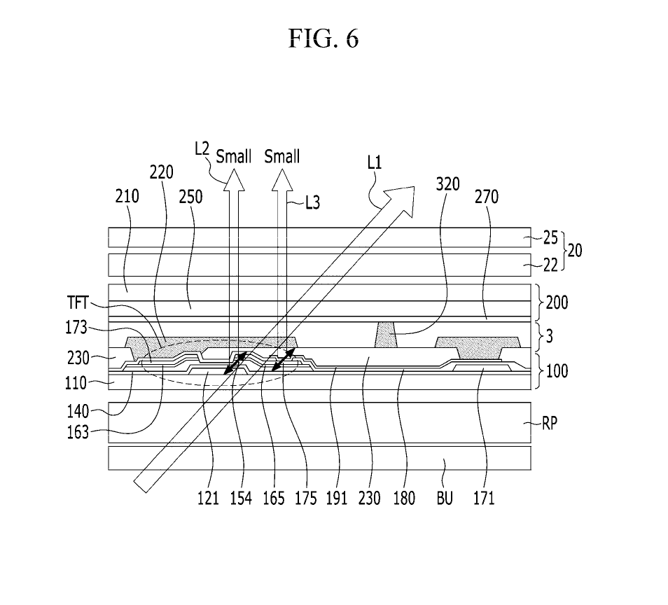

FIG. 6 is a cross-sectional view illustrating a liquid crystal display according to an exemplary embodiment of the present invention.

Referring to FIG. 6, the exemplary embodiment is almost the same as the exemplary embodiment shown in FIG. 5, but is different in that a reflective polarization film RP is adopted instead of the absorption-type first polarizer 15. In other words, the reflective polarization film RP is present between the lower panel 100 and the light source BU.

Since an absorption type polarizer including polyvinyl alcohol has transmittance of less than 50%, light efficiency is reduced to less than half after light passes through the first polarizer disposed on the lower panel. However, according to the present exemplary embodiment, it is possible to improve luminance by substituting the absorption type polarizer and with a reflective polarization film. When the reflective polarization film is used as a polarizer, light transmittance is improved by repetitive light reflection, thereby increasing luminance.

The reflective polarization film may not achieve the degree of polarization that is achieved by the existing absorption type polarizer. However, the reduced degree of polarization may be compensated by forming a compensation film as a biaxial film having a high thickness direction phase retardation value (Rth) on the upper panel 200 without forming the compensation film on the lower panel.

In the present exemplary embodiment, the reflective polarization film may have a structure in which two films having the same refractive indexes for an X-axis direction and different refractive indexes for a Y-axis direction are stacked in plural. The structure may exhibit a polarization performance because a transmission and reflection effect is differently exhibited depending on an axial direction. The plurality of films may include polyethylene naphthalate (PEN).

Another example of the reflective polarization film may be a liquid crystal composite film in which a predetermined cycle of pitch is repeated along a spiral direction. After the liquid crystal composite film transmits light matching the spiral direction and reflects light in an opposite direction, the transmitted light is changed to linear polarization by using a λ/4 retarder.

As another example of the reflective polarization film, the reflective polarization film may be a diffusing-reflective polarization film. Since a refractive index of a transmissive axis direction is the same or similar, but a refractive index of a reflection axis direction is different, the film passes the polarization in the transmissive axis direction and diffuses and reflects light in a direction vertical to a transmissive axis.

As another example of the reflective polarization film, the reflective polarization film may be a wire grid polarizer. The wire grid polarizer transmits light which is parallel with a polarization direction among incident lights and reflects light which is not parallel therewith.

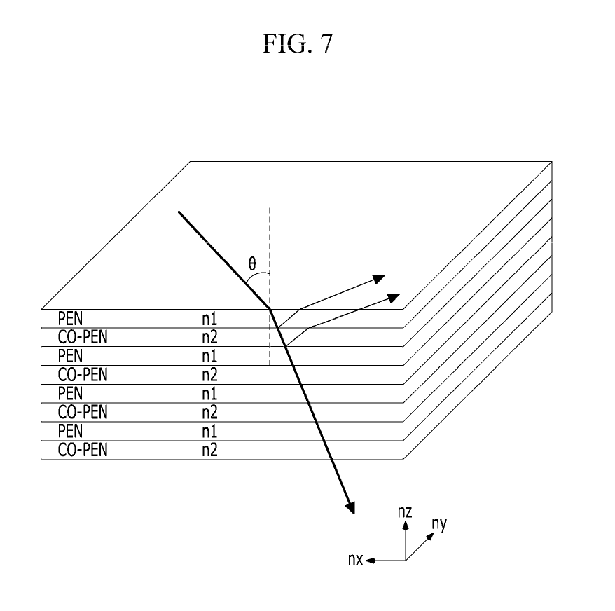

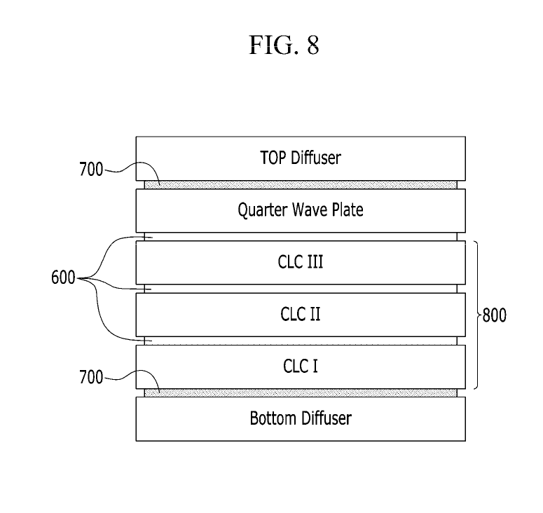

FIGS. 7 and 8 are a perspective view and a cross-sectional view illustrating a structure of the reflective polarization film used in the liquid crystal display of FIG. 6.

Specifically, FIG. 7 illustrates a reflective polarizer which is made of polyethylene naphthalene and has a structure in which two films having different refractive indexes n1, n2 depending on an axial direction are stacked in plural.

FIG. 8 illustrates a liquid crystal composite film in which diffusers are positioned at upper and lower parts and a plurality of liquid crystal films are adhered to an adhesive layer 600 in the middle, thus forming reflective layers 800 for R, G, and B wavelength regions. A λ/4 retarder (quarter wave plate) is positioned between a top diffuser and the reflective layers 800.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | | | |
|---|---|---|---|
| 10 | First optical unit | 12 | First compensation film |
| 15 | First polarizer | 20 | Second optical unit |
| 22 | Second compensation film | 25 | Second polarizer |
| 100 | Lower panel | 200 | Upper panel |
| 230 | Color filter | | |

What is claimed is:

1. A liquid crystal display, comprising:
a first substrate;
a color filter and a light blocking member disposed on the first substrate;
a second substrate corresponding to the first substrate;
a liquid crystal layer interposed between the first substrate and the second substrate;
a first polarizer disposed on the first substrate;
a compensation film disposed on the second substrate and including a biaxial film, wherein there is no compensation film disposed on the first substrate; and
a second polarizer disposed on an outer surface of the compensation film.

2. The liquid crystal display of claim 1, wherein:
a thickness direction phase retardation value of the biaxial film is about 250 nanometers to about 310 nanometers.

3. The liquid crystal display of claim 2, wherein:
an in-plane phase retardation value of the biaxial film is about 45 nanometers to about 75 nanometers.

4. The liquid crystal display of claim 1, wherein the compensation film is a second compensation film, further comprising a first compensation film disposed on the first substrate and including a phase retardation layer having an in-plane phase retardation value (Ro) of 0 and a thickness direction phase retardation value (Rth) of 0.

5. The liquid crystal display of claim 4, wherein:
the first compensation film and the second compensation film include at least one of tri-acetyl-cellulose (TAC), a cyclic olefin polymer (COP)-based resin and an acrylic polymer resin.

6. The liquid crystal display of claim 5, wherein:
the acrylic polymer resin includes polymethylmethacrylate (PMMA), and
the thickness direction phase retardation value (Rth) of the first compensation film is in the range of about −10 nanometers to 0.

7. The liquid crystal display of claim 4, wherein:
the first compensation film is interposed between the first substrate and the first polarizer.

8. The liquid crystal display of claim 1, further comprising:
a thin film transistor disposed on the first substrate;
a pixel electrode disposed on the thin film transistor;
a common electrode disposed on the second substrate; and
a spacer disposed between the first substrate and the second substrate,
wherein liquid crystal molecules of the liquid crystal layer is aligned by an electric field generated between the pixel electrode and the common electrode.

9. The liquid crystal display of claim 8, wherein:
the spacer and the light blocking member are formed of the same material.

10. The liquid crystal display of claim 1, wherein:
the compensation film is interposed between the second substrate and the second polarizer.

11. The liquid crystal display of claim 1, wherein:
the first polarizer includes a reflective polarization film.

12. The liquid crystal display of claim 11, wherein:
the first polarizer includes a structure in which two films having the same refractive indexes of an X-axis direction and different refractive indexes of a Y-axis direction are stacked in plural.

13. The liquid crystal display of claim 11, wherein:
the first polarizer includes a crystal liquid composite film in which a pitch is repeated along a spiral direction.

14. The liquid crystal display of claim 11, wherein:
the first polarizer includes a diffusing-reflective polarization film.

15. The liquid crystal display of claim 11, wherein:
the first polarizer includes a wire grid polarizer.

16. A liquid crystal display, comprising:
a first substrate;
a color filter and a light blocking member disposed on the first substrate;
a second substrate corresponding to the first substrate;
a liquid crystal layer interposed between the first substrate and the second substrate;
a first compensation film disposed on the first substrate;
a first polarizer disposed on an outer surface of the first compensation film;
a second compensation film disposed on the second substrate; and
a second polarizer disposed on an outer surface of the second compensation film,
wherein the first compensation film has an in-plane phase retardation value (Ro) in the range of about −10 nanometers to about 10 nanometers and a thickness direction phase retardation value (Rth) in the range of about −10 nanometers to about 10 nanometers, and
the second compensation film includes a biaxial film.

17. The liquid crystal display of claim 16, wherein:
the thickness direction phase retardation value of the biaxial film is about 250 nanometers to about 310 nanometers.

18. The liquid crystal display of claim 17, wherein:
an in-plane phase retardation value of the biaxial film is about 45 nanometers to about 75 nanometers.

19. The liquid crystal display of claim 18, wherein:
the first compensation film and the second compensation film include at least one of tri-acetyl-cellulose (TAC), a cyclic olefin polymer (COP)-based resin and an acrylic polymer resin.

20. The liquid crystal display of claim 16, further comprising:
a thin film transistor disposed on the first substrate;
a pixel electrode disposed on the thin film transistor;
a common electrode disposed on the second substrate; and
a spacer disposed between the first substrate and the second substrate,
wherein liquid crystal molecules of the liquid crystal layer is aligned by an electric field generated between the pixel electrode and the common electrode.

21. The liquid crystal display of claim 20, wherein:
the spacer and the light blocking member are formed of the same material.

22. The liquid crystal display of claim 16, wherein:
the first compensation film is interposed between the first substrate and the first polarizer.

23. The liquid crystal display of claim 22, wherein:
the second compensation film is interposed between the second substrate and the second polarizer.
